(19) United States
(12) Patent Application Publication
(10) Pub. No.: US 2001/0051245 A1
(43) Pub. Date: Dec. 13, 2001

(54) Motor vehicle body part in a sandwich construction

(76) Inventor: Wolfgang Seifert, Germering (DE)

Correspondence Address: NIXON PEABODY, LLP, 8180 GREENSBORO DRIVE, SUITE 800, MCLEAN, VA, 22102, US

(21) Appl. No.: 09/835,832

(22) Filed: Apr. 17, 2001

(30) Foreign Application Priority Data
Apr. 17, 2000 (DE) 100 19 199.1

(51) Int. Cl. B32B 3/10

(52) U.S. Cl. 428/40.1; 428/138

(57) ABSTRACT

Motor vehicle body part, especially a motor vehicle roof, which is built in a sandwich construction in layers out of an outside shell (11, 12) and an inside shell (13, 14) which is based on a foam layer (13). The two shells (11, 12; 13, 14) are detachably joined to one another by adhesion. By means of this measure in case of repair the inside shell (13, 14) can be easily pulled off the outside shell (11, 12) and can be replaced by a corresponding replacement part which is optionally made self-adhesive. The motor vehicle body part (10) as claimed in the invention is produced advantageously in a serial follow-on tool.

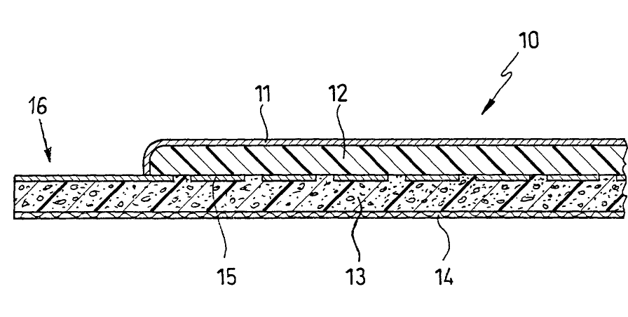

### BACKGROUND OF THE INVENTION

1. Field of the Invention

The invention relates to a motor vehicle body part, especially a motor vehicle roof, which is built in a sandwich construction in layers, out of an outside shell and an inside shell which is based on a foam layer.

2. Description of Related Art

One such motor vehicle body part in the form of a motor vehicle roof is known, for example, from International Patent Application Publication WO 98/39170 (corresponding to DE 197 09 016 A1). This known roof comprises an inside shell and an outside shell which are modularly produced separately are joined into an inseparable one-piece construction. The inside shell which forms the headliner projects on all sides beyond the outside edges of the motor vehicle roof, and thus, is larger than the inside dimensions of the body opening which is bordered by the crossbeams or profiles of the body frame. These projecting outside edges of the inside shell are flexible or elastic, such that they can be bent for passage through the body openings bordered by the body frame with partial folding downward in the corner areas, without residual deformation, and are used for covering the body frame, by which additional cover strips and cover profiles in the corner areas also become unnecessary. However, the defect in this known motor vehicle roof is that the inside shell which forms the headliner cannot be dismounted later. In addition, this motor vehicle roof requires relative complex slides in the foaming tool.

Another separately prefabricated motor vehicle roof is known from published German Patent Application DE 33 29 407 A1. This motor vehicle roof is detachably locked on the roof frame of the vehicle by means of locking strips, and thus, can be subsequently removed as a whole from the motor vehicle.

Published German Patent Application DE 42 32 689 A1 discloses a motor vehicle roof covering which comprises an inside decorative later and an absorber layer which is a foam layer backing of the decorative layer. In addition, this roof covering comprises a carrier layer, another absorber and a moisture barrier. The carrier is made, for example, of a perforated corrugated cardboard filled with an absorber.

### SUMMARY OF THE INVENTION

In view of this prior art, a primary object of the invention is to devise a motor vehicle body part of the initially mentioned type which easily ensures subsequent replacement of the inside shell of the properly installed motor vehicle body part.

This object is achieved by a motor vehicle body part the inside shell being detachably joined to the outside shell by adhesion. An economical and simple process for producing the motor vehicle body part is achieved by producing the foam layer of the outside shell, and then applying the separation medium to it, followed by production of the foam layer of the inside shell on it.

The motor vehicle body part according to the invention thus, likewise, represents a prefabricated component like the initially mentioned generic motor vehicle body part. However, in contrast to this known motor vehicle body part, the two shells are not permanently joined to one another, but instead are detachably connected by adhesion or partial cohesion so that, at any time, the inside shell, in the case of a motor vehicle roof the vehicle headliner, can be pulled off the outside shell and can be replaced, for example, by a self-adhesive replacement part.

The connection of the two shells by adhesion has the further advantage that the inside shell, which in the motor vehicle typically forms an inside lining, is loosened partially from the outside shell for installation, and thereupon, can be joined again to the outside shell. The installation of the motor vehicle body part on the motor vehicle is thus made simple.

The adhesive connection of the two shells of the motor vehicle body part makes connecting elements between the outside shell and the inside shell superfluous.

According to another development of the invention, the adhesion between the two shells of the motor vehicle body part is distributed in the manner of a grid so that specifically partial adhesion between the two shells is provided which ensures sufficient connection of these two parts as well as their subsequently easy separation.

The adhesive connection of the two shells of the motor vehicle body part can be accomplished fumdamentally in the most varied ways. Accordingly, for example, there can be an adhesive film between the two shells which is attached in the course of manufacture of the body sandwich part to one of the two shells before the other shell is formed thereon. However, a partial adhesive connection of the two shells, i.e., a partial connection with respect to the entire connecting surface, is advantageously produced by a suitable separating means. This separating means can be provided in the form of a film with grid of holes or as a screened layer which is applied to one or both shells in perforated grid pattern.

According to a version of the invention which is advantageous also with respect to production, not only the inside, but also the outside shell comprises a foam layer. The foam layer of the outside shell is preferably formed from hard foam, while the inside shell which provides the inside motor vehicle lining is preferably formed from soft foam. Both foam layers can be covered externally by protective layers. Thus, for example, the outside of the foam layer of the outside shell is covered by a cover layer of plastic or sheet metal, while the outside of the foam layer of the inside shell is covered, for example, by plastic or fabric forming, for example, a decorative layer.

The motor vehicle body part in accordance with the invention having the two shells connected to one another by adhesion can advantageously be produced by a process which uses a follow-on tool in which, after producing the foam layer of the outside shell, the separation medium is applied on it to provide partial adhesion, and then the foam layer of the inside shell is produced on it, with a cover layer applied thereupon if necessary. The corresponding cover layer of the foam layer of the outside shell is, if necessary, located in the follow-on tool before production of this foam layer. In the case in which the inside shell is to be replaced after installation of the motor vehicle body part, for example, in the case of repair, the replacement part, which is advantageously made self-adhesive, can be produced in the same serial follow-on tool which was used for producing the original motor vehicle body part.

The invention is explained in detail below by way of example using the drawings

### BRIEF DESCRIPTION OF THE DRAWINGS

The sole FIGURE schematically shows the layer structure of the prefabricated motor vehicle body part in accordance with the invention which is used, for example, as a motor vehicle roof.

### DETAIL DESCRIPTION OF THE INVENTION

The prefabricated motor vehicle body part in accordance with the invention is generally labeled with reference number 10. This prefabricated motor vehicle body part 10 is conventionally prepared in a sandwich construction and in the FIGURE comprises, from top to bottom, and in the practical application from the outside to the inside, a first cover layer 11, a first foam layer in the form of a hard foam layer 12, a second foam layer in the form of a soft foam layer 13, and a second cover layer 14. The first cover layer 11 is made, for example, of plastic or of sheet metal and forms the outside skin of the body part or of the motor vehicle roof 10, while the second cover layer 14 is formed, for example, as a decorative layer, preferably from fabric, and the inside skin of the body part or of the motor vehicle roof 10, in this case, therefore forms the headliner.

The combination of the first cover layer 11 and the hard foam layer 12 forms the outside shell of this motor vehicle roof 10 which is made as a prefabricated part, while the soft foam layer 13 and the second cover layer 14 form its inside shell. In the embodiment of the uninstalled motor vehicle roof 10 shown in the FIGURE, the inside shell 13, 14 projects beyond the outside shell 11, 12, the projecting edge 16 of the inside shell 13, 14 being used for connection of the motor vehicle roof 10 to the remaining body structure.

In accordance with the invention, the two shells 11, 12 and 13, 14 are detachably joined to one another by adhesion. For this purpose, between the hard foam layer 12 and the soft foam layer 13 there is a separating means in the form of a film 15 having grid pattern of holes, the film 15 extending also into the projecting edge area 16 of the soft foam layer 13 in the embodiment shown. By perforation of the film 15 with the grid pattern of holes, specific partial adhesion between the soft foam layer 13 and the hard foam layer 12 is created so that these two layers adhere to one another solely in the area of the holes or perforations of the film 15. A film with a grid pattern of holes can also be formed by producing the film 15 as a silk screened pattern on one of the two foam layers 12, 13, this pattern likewise being made preferably as a perforated grid in order to achieve specific partial adhesion between the two layers 12, 13. The size and number of the adhesion points which are provided by the film 15 with the pattern of holes are chosen such that adhesion is great enough to securely join the inside shell 13, 14 to the outside shell 11, 12, yet, on the other hand, is low enough for it to be possible to subsequently separate the inside shell 13, 14 from the outside shell 11, 12 at any time by pulling it off. This separation of the inside shell from the outside shell or the soft foam layer 13 from the hard foam layer 12 can become necessary, for example, in case where repairs are required. The removed inside shell is replaced after making the repairs by a replacement part which is made, for example, self-adhesive.

The motor vehicle roof 10 formed as a prefabricated component is produced, advantageously, in a follow-on tool. In the follow-on tool, for example, first the combination of the first cover layer 11 and the hard foam layer 12 is produced, whereupon the separating means is applied in the form of, for example, a film 15 with a grid pattern of holes to the free surface of the hard foam layer 12. In another subsequent step, then the soft foam layer 13 is formed on the film 15, by which this soft foam layer 13 passes through the holes of the film 15 for adhesion to the hard foam layer 12. Thereupon, the second cover layer 14 is applied on the free surface of the soft foam layer 13, by which the motor vehicle roof 10 is finished as a prefabricated component and can be mounted on the motor vehicle body.

The motor vehicle body part according to the invention was explained above using a motor vehicle prefabricated roof by way of example. However, the invention is not limited thereto. Rather, other body parts can also be built and produced in the manner as described above in accordance with the invention.

What is claimed is:

1. Motor vehicle body part of a sandwich construction of layers, comprising an outside shell and an inside shell with a foam layer, wherein the two shells are detachably joined to one another by an adhesive connection.

2. Motor vehicle body part as claimed in claim 1, wherein the adhesive connection is formed between parts of the two shells in a grid pattern.

3. Motor vehicle body part as claimed in claim 2, wherein said grid pattern is provided by a separating layer located between the two shells through which said adhesive connection is formed.

4. Motor vehicle body part as claimed in claim 3, wherein the separating layer is a film and the grid pattern is formed by holes in the film.

5. Motor vehicle body part as claimed in claim 3, wherein the separating means layer comprises a screened-on layer with a grid pattern of openings applied to at least one of the shells.

6. Motor vehicle body part as claimed in claim 1, wherein the outside shell has a foam layer, and wherein the adhesive connection of the two shells is formed between the foam layers of the shells.

7. Motor vehicle body part as claimed in claim 6, wherein the foam layer of the outside shell is hard foam.

8. Motor vehicle body part as claimed in claim 7, wherein the foam layer of the inside shell is a soft foam layer.

9. Motor vehicle body part as claimed in claim 7, wherein an outer side of the foam layer of the outside shell is covered by a cover layer.

10. Motor vehicle body part as claimed in claim 9, wherein the cover layer is made of sheet metal.

11. Motor vehicle body part as claimed in claim 9, wherein the cover layer is made of plastic.

12. Motor vehicle body part as claimed in claim 1, wherein the outer side of the foam layer of the inside shell is covered by another cover layer.

13. Motor vehicle body part as claimed in claim 12, wherein the cover layer of the inside shell is made of fabric.

14. Motor vehicle body part as claimed in claim 11, wherein the vehicle body part is a motor vehicle roof part.

15. Process for producing a motor vehicle body part having a sandwich construction of layers with an outside shell joined an inside shell by a detachable adhesive connection, wherein production takes place in a follow-on tool, comprising the steps of:
producing a foam layer of the outside shell,
applying a separation medium to the foam layer of the outside shell,
producing the inside shell on the separation medium and forming detachable adhesive connection between the inside shell and the outside shell through the separation medium.

16. Process for producing a motor vehicle body part according to claim 15, wherein the separation medium is applied as a film having a grid pattern of holes through which the foam layer of the inside shell is adhered to the foam layer of the outside shell.

17. Process for producing a motor vehicle body part according to claim 15, wherein the separation medium is applied as a silk screened layer having a grid pattern of openings through which the foam layer of the inside shell is adhered to the foam layer of the outside shell.
